(19) United States
(12) Patent Application Publication
(10) Pub. No.: US 2022/0412222 A1
(43) Pub. Date: Dec. 29, 2022

(54) ATTACHMENT STRUCTURES FOR AIRFOIL BANDS

(71) Applicant: General Electric Company, Schenectady, NY (US)

(72) Inventors: Alexander Martin Sener, Santa Monica, CA (US); Matthew Mark Weaver, Loveland, OH (US); Lauren Rose Watson, West Chester, OH (US)

(21) Appl. No.: 17/358,441

(22) Filed: Jun. 25, 2021

(51) Int. Cl. F01D 9/04; F01D 25/24

(52) U.S. Cl. CPC F01D 9/042; F01D 9/041; F01D 25/246; F05D 2300/6033; F05D 2240/12; F05D 2240/80

(57) ABSTRACT

An airfoil assembly defines an axial direction, a radial direction, and a circumferential direction, and includes an airfoil and an outer band disposed on an outer end of the airfoil in the radial direction. The outer band includes an outer attachment structure configured to secure the outer band to an outer support structure on an outer side of the outer band.

### FEDERALLY SPONSORED RESEARCH

This invention was made with government support under contract number FA8650-15-D-2501 awarded by United States Air Force. The U.S. government may have certain rights in the invention.

### FIELD

The present subject matter relates generally to gas turbine engines. More specifically, the subject matter relates to attachment structures for airfoil bands for airfoils of gas turbine engines.

### BACKGROUND

Gas turbine engines include various components that are subjected to high temperatures. As an example of such components, turbine airfoils downstream of a combustor of the gas turbine engine experience extremely high temperatures.

For components that experience such high temperatures, non-traditional high temperature composite materials, such as ceramic matrix composite (CMC) materials, may be used. Composite materials typically include reinforcement materials and matrix materials. CMC materials are a type of composite materials in which both the reinforcement materials and matrix materials are formed of ceramics. The reinforcement materials and matrix materials may be formed of the same type of ceramics, or different types of ceramics. Components fabricated from CMC materials have a higher temperature capability compared with typical components, e.g., metal components, which may allow improved component performance and/or increased system temperatures, with reduced cooling flow to the CMC components.

However, it may be desirable to account for differences in mechanical properties of CMC components compared to conventional components during design and application of the CMC components as well as surrounding components.

### BRIEF DESCRIPTION

Aspects and advantages of the disclosure will be set forth in part in the following description, or may be obvious from the description, or may be learned through practice of the disclosure.

The present disclosure is directed to an airfoil assembly for a turbine engine defining an axial direction, a radial direction, and a circumferential direction.

According to one or more embodiments, an airfoil assembly defines an axial direction, a radial direction, and a circumferential direction, and comprises an airfoil and an outer band disposed on an outer end of the airfoil in the radial direction, wherein the outer band comprises an outer attachment structure configured to secure the outer band to an outer support structure on an outer side of the outer band.

According to one or more embodiments, the airfoil and the outer band are formed of or includes ceramic matrix composite (CMC).

According to one or more embodiments, the outer attachment structure comprises a first outer hook that radially extends from or near a first axial end of the outer band, and a second outer hook that radially extends from or near a second axial end of the outer band, and the first and second outer hooks are configured to slide onto the outer support structure in the circumferential direction to removably secure the airfoil assembly on the outer support structure.

According to one or more embodiments, terminal ends of the first and second outer hooks extend towards each other in the axial direction.

According to one or more embodiments, the outer attachment structure comprises a first outer flange that radially extends from or near a first axial end of the outer band, and a second outer flange that radially extends from or near a second axial end of the outer band, the first outer flange defines a first opening extending in the axial direction, the second outer flange defines a second opening extending in the axial direction, and the first and second openings are configured to have pins pass therethrough to corresponding openings on the outer support structure to removably secure the airfoil assembly on the outer support structure.

According to one or more embodiments, the first outer flange is on an upstream side of the outer attachment structure relative to the second outer flange in the axial direction.

According to one or more embodiments, the first opening is elongate and is larger in the circumferential direction than the radial direction.

According to one or more embodiments, the airfoil assembly further comprises a radial abutment surface that extends from an upper surface of the outer band, the radial abutment surface faces an upstream side in the axial direction, the radial abutment surface is separate from the first outer flange and the second outer flange, and the radial abutment surface is configured to abut a corresponding abutment surface of the outer support structure.

According to one or more embodiments, the first outer flange is tab-shaped and is configured to extend radially through an aperture in the outer support structure.

According to one or more embodiments, the airfoil assembly further comprises a third outer flange that is tab-shaped, the third outer flange is configured to extend radially through another aperture in the outer support structure, the third outer flange is disposed adjacent to the second outer flange in the circumferential direction and the third outer flange has a third opening configured to have a pin pass therethrough to a corresponding opening on the outer support structure.

According to one or more embodiments, upstream surfaces of the first and second outer flanges in the axial direction are configured to abut radial surfaces of the outer support structure.

According to one or more embodiments, the airfoil and the outer band are formed as separate pieces.

According to one or more embodiments, further comprises an inner band disposed on an inner end of the airfoil in the radial direction, wherein the inner band comprises an inner attachment structure configured to removably secure the inner band to an inner support structure on an inner side of the inner band.

According to one or more embodiments, the inner attachment structure comprises a first inner hook that radially extends from or near a first axial end of the inner band, and a second inner hook that radially extends from or near a second axial end of the inner band, and the first and second inner hooks are configured to slide onto the inner support structure in the circumferential direction to removably secure the airfoil assembly on the inner support structure.

According to one or more embodiments, the inner attachment structure comprises a first inner flange that radially extends from or near a first axial end of the inner band, and a second inner flange that radially extends from or near a second axial end of the inner band, the first inner flange comprises a first opening in the axial direction, the second inner flange comprises a second opening in the axial direction, and the first and second openings are configured to have pins pass therethrough to corresponding openings on the inner support structure to removably secure the airfoil assembly on the inner support structure.

According to one or more embodiments, the first inner flange is on an upstream side of the second inner flange in the axial direction.

According to one or more embodiments, the first opening is elongate and is larger in the circumferential direction than the radial direction.

According to one or more embodiments, a downstream surface of the first inner flange and an upstream surface of the second inner flange are configured to abut the inner support structure.

According to one or more embodiments, a gas turbine engine comprises an outer support structure, and an airfoil assembly defining an axial direction, a radial direction, and a circumferential direction, and comprising an airfoil, an outer band disposed on an outer end of the airfoil in the radial direction, and an inner band disposed on an inner end of the airfoil in the radial direction, the outer band comprises an outer attachment structure configured to secure the outer band to an outer support structure on an outer side of the outer band, the outer band comprises an attachment structure, and the attachment structure attaches the outer band to the outer support structure.

According to one or more embodiments, a method of assembling an airfoil assembly onto an outer support structure, the airfoil assembly defining an axial direction, a radial direction, and a circumferential direction, and comprising an airfoil, an outer band disposed on an outer end of the airfoil in the radial direction, and an inner band disposed on an inner end of the airfoil in the radial direction, comprises attaching the outer band to the outer support structure via an attachment structure of the outer band, wherein attaching the outer band to the outer support structure comprises one of sliding first and second outer hooks that radially extend from or near axial ends of the outer band onto the outer support structure in the circumferential direction, and passing securing pins in the axial direction through first and second outer flanges that radially extend from or near axial ends of the outer band and through flanges of the outer support structure.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of a gas turbine engine according to one or more embodiments.

FIG. 2 is a perspective view of a nozzle ring of a gas turbine engine according to one or more embodiments.

FIG. 3 is a perspective view of an airfoil assembly according to one or more embodiments having attachment structures removed for clarity to describe certain aspects of the airfoil assembly.

FIG. 4 is a perspective view of an airfoil assembly according to one or more embodiments having attachment structures removed for clarity to describe certain aspects of the airfoil assembly.

FIG. 5 is an exploded perspective view of an airfoil assembly according to one or more embodiments having attachment structures removed for clarity to describe certain aspects of the airfoil assembly.

FIG. 6 shows an airfoil assembly having attachment structures for outer and inner bands according to one or more embodiments, viewed from a forward direction.

FIG. 7 shows an airfoil assembly having attachment structures for outer and inner bands according to one or more embodiments, viewed from a forward and radial outer direction.

FIG. 8 shows an airfoil assembly having attachment structures for outer and inner bands according to one or more embodiments, viewed from an aft and radial outer direction.

FIG. 9 shows an airfoil assembly having attachment structures for outer and inner bands according to one or more embodiments, viewed from an aft and radial inner direction.

FIG. 10 shows an airfoil assembly having attachment structures for outer and inner bands according to one or more embodiments, viewed from a forward and radial inner direction.

FIG. 11A is a cross-sectional view from a radial direction of an attachment structure according to one or more embodiments.

FIG. 11B is a cross-sectional view from a radial direction of an attachment structure according to one or more embodiments.

FIG. 11C is a cross-sectional view from a radial direction of an attachment structure to one or more embodiments.

FIG. 11D is a cross-sectional view from a radial direction of an attachment structure according to one or more embodiments.

FIG. 11E is a cross-sectional view from a radial direction of an attachment structure according to one or more embodiments.

FIG. 11F is a cross-sectional view from a radial direction of an attachment structure according to one or more embodiments.

FIG. 12 is a cross-sectional view from a circumferential direction of an airfoil assembly having attachment structures for outer and inner bands according to one or more embodiments.

FIG. 13A shows an outer band having attachment structures according to one or more embodiments viewed from a radial inner direction.

FIG. 13B shows an inner band having attachment structures according to one or more embodiments viewed from a radial outer direction.

FIG. 14A shows a method of assembling an airfoil assembly onto an outer hanger according to one or more embodiments.

FIG. 14B shows a method of assembling an airfoil assembly onto an inner hanger according to one or more embodiments.

FIG. 14C shows a method of assembling an airfoil assembly onto an outer hanger according to one or more embodiments.

FIG. 14D shows a method of assembling an airfoil assembly onto an inner hanger according to one or more embodiments.

Repeat use of reference characters in the present specification and drawings is intended to represent the same or analogous features or elements of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components. As used herein, being “near” an axial end of a structure may be defined as being within a distance from the axial end that is 20% of an entire axial dimension of the structure. As used herein, the term “removably” in the context of attaching and/or securing indicates that the element may be removed without breaking any of the elements being attached/secured, or breaking any of the elements being used to attach/secure.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The terms “upstream” and “downstream” refer to the relative direction with respect to fluid flow in a fluid pathway. For example, “upstream” refers to the direction from which the fluid flows, and “downstream” refers to the direction to which the fluid flows.

Turbine nozzles may contain at least three elements that are exposed to a gas path: an airfoil, an inner band, and an outer band. According to one or more embodiments, these three elements are formed as an integral unit, e.g., by casting or composite layups. However, according to one or more embodiments, the airfoil, the inner band, and the outer band may be formed separately and then assembled. Forming these elements separately may simplify manufacturing for cost-out and yield. Additionally, forming them separately and assembling them may result in decreasing and/or eliminating stresses at the airfoil to band interfaces. One or more embodiments may effectively locate and attach outer and inner bands to outer and inner hangers, respectively. Furthermore, one or more embodiments may maintain the fit, function, and location of the bands separate from the airfoils.

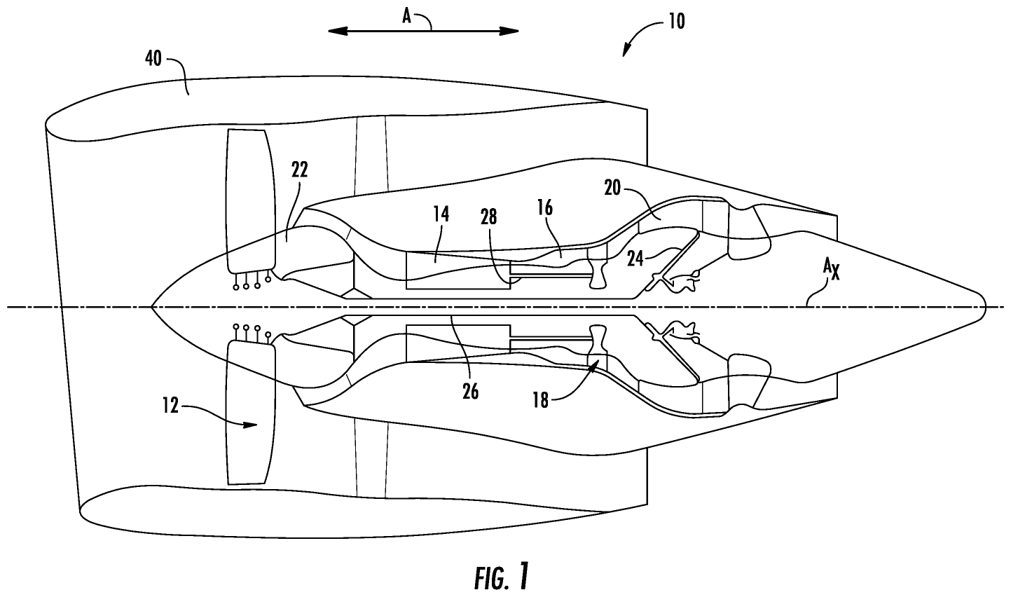

FIG. 1 is a schematic view of a gas turbine engine 10 according to one or more embodiments. The gas turbine engine 10 includes a low-pressure compressor 12, a high-pressure compressor 14, and a combustor assembly 16. The gas turbine engine 10 further includes a high-pressure turbine 18 and a low-pressure turbine 20 arranged in a serial, axial flow relationship on respective rotors 22 and 24. The low-pressure compressor 12 and the low-pressure turbine 20 may be coupled by a first shaft 26, and the high-pressure compressor 14 and the high-pressure turbine 18 may be coupled by a second shaft 28.

During operation, air flows along a central axis Ax of the gas turbine engine 10. As shown in the drawings, the gas turbine engine 10 defines an axial direction A in which the central axis Ax extends, a circumferential direction C extending around the central axis Ax, and a radial direction R extending perpendicularly outwards from the central axis Ax. The low-pressure compressor 12 compresses incoming air, and the compressed air is in turn supplied to the high-pressure compressor 14 which further compresses the compressed air from the low-pressure compressor 12. The air compressed by the high-pressure compressor 14 is delivered to combustor assembly 16 which combusts the compressed air. Exhaust gas flows from the combustor assembly 16 drives the high-pressure and low-pressure turbines 18 and 20. The high-pressure turbine 18 drives the high-pressure compressor 14 by way of the second shaft 28, and the low-pressure turbine 20 drives fan or low-pressure compressor 12 by way of the first shaft 26. The gas turbine engine 10 also includes a fan or low-pressure compressor containment case 40.

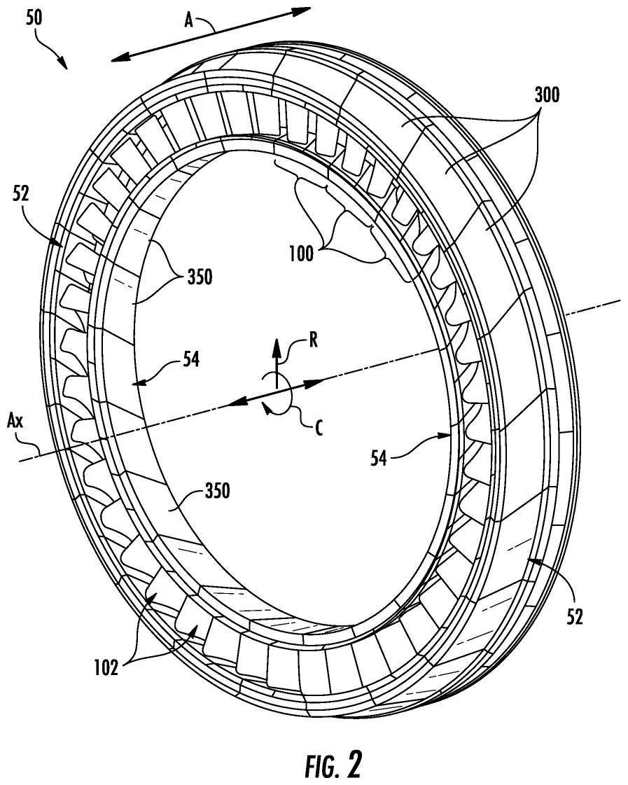

FIG. 2 is a perspective view of a nozzle ring 50 according to one or more embodiments. For example. the nozzle ring 50 may be located within high-pressure turbine 18 and/or low-pressure turbine 20 (shown in FIG. 1). The nozzle ring 50 is formed of one or more turbine nozzle segment assemblies 100. The nozzle segment assemblies 100 direct combustion gases downstream through a subsequent row of rotor blades extending radially outwardly from supporting rotor 22 or 24 (shown in FIG. 1). The nozzle ring 50 and the plurality of nozzle segment assemblies 100 thereof may facilitate extracting energy by the rotor 22 or 24 (shown in FIG. 1). Furthermore, the nozzle ring 50 may be used in the high-pressure compressor 14 or the low-pressure compressor 12.

The nozzle ring 50 is formed of a plurality of nozzle segment assemblies 100. Each of the nozzle segment assemblies 100 may include at least one airfoil assembly 102, an outer hanger 300, and an inner hanger 350. In one or more embodiments, the outer hanger 300, the inner hanger 350, or both may be a continuous ring. Alternatively, the nozzle ring 50 may include an outer hanger 300 for each or several of the plurality of nozzle segment assemblies 100, and the plurality of outer hangers 300 of the plurality of nozzle segment assemblies 100 may cooperate to form an outer ring 52 of the nozzle ring 50. Similarly, in one or more embodiments, the nozzle ring 50 may include an inner hanger 350 for each or several of the nozzle segment assemblies 100, and the plurality of inner hangers 350 of the plurality of nozzle segment assemblies 100 may cooperate to form an inner ring 54 of the nozzle ring 50. The outer ring 52 and the inner ring 54 extend circumferentially 360 degrees about the center axis Ax of the gas turbine engine 10. The plurality of airfoil assemblies 102 may be disposed radially between the outer hangers 300 of the outer ring 52 and the inner hangers 350 of the inner ring 54.

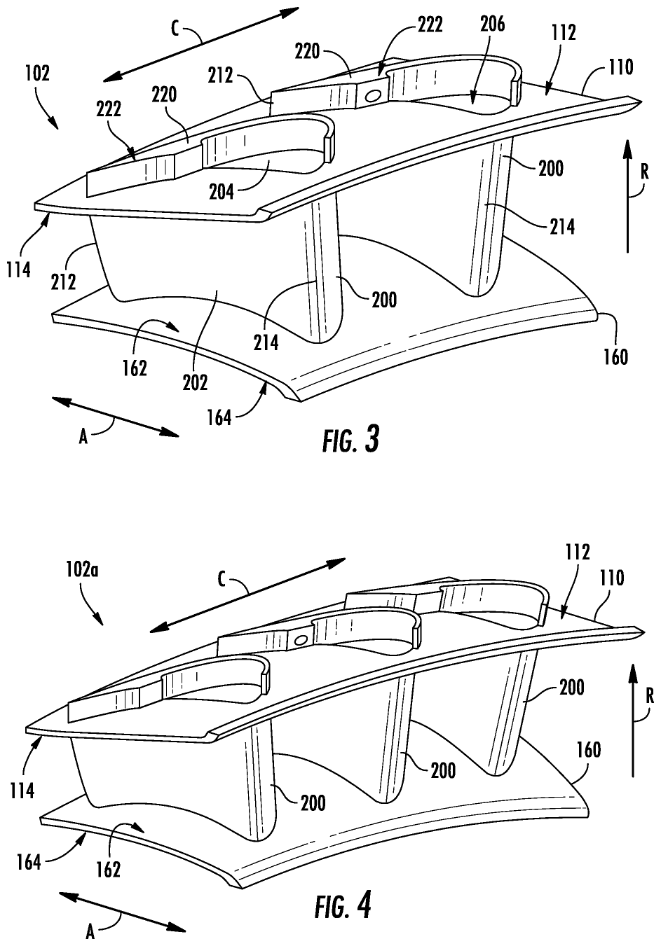

FIG. 3 is a perspective view of an airfoil assembly 102 according to one or more embodiments having attachment structures removed for clarity to describe certain aspects of the airfoil assembly 102. The airfoil assembly 102 may include an outer band 110 having an outward facing surface 112 that faces outward in the radial direction R, an inner band 160 having an inward facing surface 164 that faces inward in the radial direction R, and at least one airfoil 200 extending between the outer band 110 and the inner band 160. Each airfoil assembly 102 may include one or a plurality of airfoils 200. As shown in FIG. 2, in one or more embodiments, each of the plurality of airfoil assemblies 102 may be a singlet comprising a single airfoil 200 extending between the outer band 110 and the inner band 160. Alternatively, as shown in FIG. 3, in one or more embodiments, each of the plurality of airfoil assemblies 102 may be a doublet comprising two airfoils 200 extending between the outer band 110 and the inner band 160. Alternatively, as shown in FIG. 4, in one or more embodiments, each of the plurality of airfoil assemblies 102 may be a triplet comprising three airfoils 200 extending between the outer band 110 and the inner band 160. Furthermore, in one or more embodiments, each of the airfoil assemblies 102 may include four or more airfoils 200. For example, although the embodiments of FIGS. 5-13B, discussed below, show airfoil assemblies 102 having two airfoils 200, the airfoil assemblies 102 depicted therein may have more or less than the two airfoils 200 shown in FIGS. 5-13B.

According to one or more embodiments, the outer band 110, the inner band 160, and the at least one airfoil 200 may include a material having a low coefficient of thermal expansion. In one or more embodiments, the outer band 110, the inner band 160, and the at least one airfoil 200 may be formed of, or may include, a ceramic matrix composite (CMC) material. CMC materials are a type of composite materials in which both the reinforcement materials and matrix materials are formed of ceramics. The reinforcement materials and matrix materials may be formed of the same type of ceramics, or different types of ceramics. Alternatively, the outer band 110, the inner band 160, and the at least one airfoil 200 may be formed of other materials having low coefficients of thermal expansion.

FIG. 5 is an exploded perspective view of an airfoil assembly 102 according to one or more embodiments having attachment structures removed for clarity to describe certain aspects of the airfoil assembly 102. The outer band 110 may include an outward facing surface 112 that faces outward in the radial direction R, an inward facing surface 114 that faces inward in the radial direction R, and one or a plurality of openings 116 extending through the thickness of the outer band 110 from the outward facing surface 112 to the inward facing surface 114. The outward facing surface 112 may be a surface of the outer band 110 facing outward in the radial direction R away from the center axis Ax of the gas turbine engine 10. The inward facing surface 114 may be a surface of the outer band 110 facing inward in the radial direction R towards the center axis Ax of the gas turbine engine 10. The outward facing surface 112 and inward facing surface 114 may be curved in the circumferential direction C. Each of the openings 116 may be shaped to receive the outer end 220 of one of the airfoils 200 so that at least a portion of the outer end 220 of the airfoil 200 passes through the opening 116 and protrudes outward in the radial direction R from the outward facing surface 112 of the outer band 110. Alternatively, the outer end 220 of the airfoil 200 may abut the inward facing surface 114 such that the outer end 220 is in the flowpath of the outer band 110, with an appropriate seal therebetween.

The outer band 110 may also have a forward edge 120 and an aft edge 122. The forward edge 120 may be an edge of the outer band 110 facing the axial direction A towards the engine inlet. The aft edge 122 may be an edge of the outer band 110 facing the axial direction A towards the engine outlet.

According to one or more embodiments, the inner band 160 may include an outward facing surface 162 that faces outward in the radial direction R, an inward facing surface 164 that faces inward in the radial direction R, and one or a plurality of openings 166 extending through the thickness of the inner band 160 from the outward facing surface 162 to the inward facing surface 164. The outward facing surface 162 may be a surface of the inner band 160 facing outward in the radial direction R away from the center axis Ax of the gas turbine engine 10. The inward facing surface 164 may be a surface of the inner band 160 facing inward in the radial direction R towards the center axis Ax of the gas turbine engine 10. The outward facing surface 162 and inward facing surface 164 may be curved in the circumferential direction. Each of the openings 166 in the inner band 160 may be shaped to receive the inner end 240 of one of the airfoils 200 so that at least a portion of the inner end 240 of the airfoil 200 passes through the opening 166 and protrudes inward in the radial direction R from the inward facing surface 164 of the inner band 160. Alternatively, the inner end 240 of the airfoil 200 may abut the outward facing surface 162 such that the inner end 240 is in the flowpath of the inner band 160, with an appropriate seal therebetween.

The inner band 160 may also have a forward edge 170 and an aft edge 172. The forward edge 170 may be an edge of the inner band 160 facing the axial direction A towards the engine inlet. The aft edge 172 may be an edge of the inner band 160 facing the axial direction A towards the engine outlet.

According to one or more embodiments, the airfoils 200 may be hollow or solid. If the airfoils 200 are hollow, each of the airfoils 200 may include an exterior surface 202 and an interior surface 204. The exterior surface 202 of the airfoil 200 may be the surface of the airfoil 200 facing away from the airfoil 200 and may have an airfoil shape. The general airfoil shape of the exterior surface 202 of the airfoil 200 is not particularly limited so long as each airfoil 200 includes a suction side 218 and a pressure side 219. The interior surface 204 of the airfoil 200 may be oriented facing inward and may define a cavity 206 extending through the airfoil 200 from the outer end 220 to the inner end 240 of the airfoil 200.

Each airfoil 200 may have a forward edge 210 oriented in the axial direction A towards the inlet of the gas turbine engine 10 and an aft edge 212 oriented in the axial direction A towards the outlet of the gas turbine engine 10. Each airfoil 200 includes the outer end 220 and the inner end 240. The outer end 220 of the airfoil 200 may be shaped to engage with the outer band 110. For example, the outer end 220 of the airfoil 200 may be shaped so that the outer end 220 of the airfoil 200 extends through one of the openings 116 in the outer band 110 and protrudes outward in the radial direction R from the outward facing surface 112 of the outer band 110. In one or more embodiments, at least a portion of the outer end 220 of the airfoil 200 may provide an abutting surface that contacts the inward facing surface 114 of the outer band 110 to properly position the airfoil 200 with respect to the outer band 110. The inner end 240 of the airfoil 200 may be shaped to engage with the inner band 160. For example, the inner end 240 of the airfoil 200 may be shaped so that the inner end 240 of the airfoil 200 extends through one of the openings 166 in the inner band 160 and protrudes inward in the radial direction R from the inward facing surface 164 of the inner band 160. In one or more embodiments, at least a portion of the inner end 240 of the airfoil 200 may provide an abutting surface that contacts the outward facing surface 162 of the inner band 160 to properly position the airfoil 200 with respect to the inner band 160.

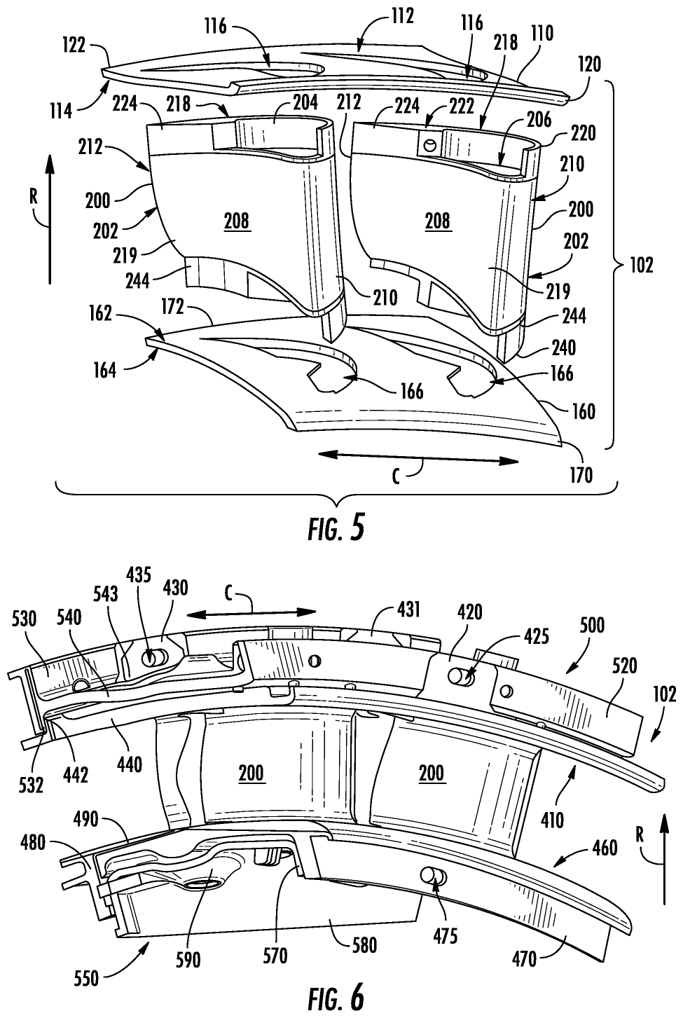

FIGS. 6-13B illustrate airfoil assemblies 102 having attachment structures for outer and inner bands 410, 460 according to different embodiments. While these attachment structures are not shown in FIGS. 3-5 for ease of explanation, it will be appreciated that the attachment structures shown in FIGS. 6-13B may be incorporated into the airfoil assemblies shown in FIGS. 3-5.

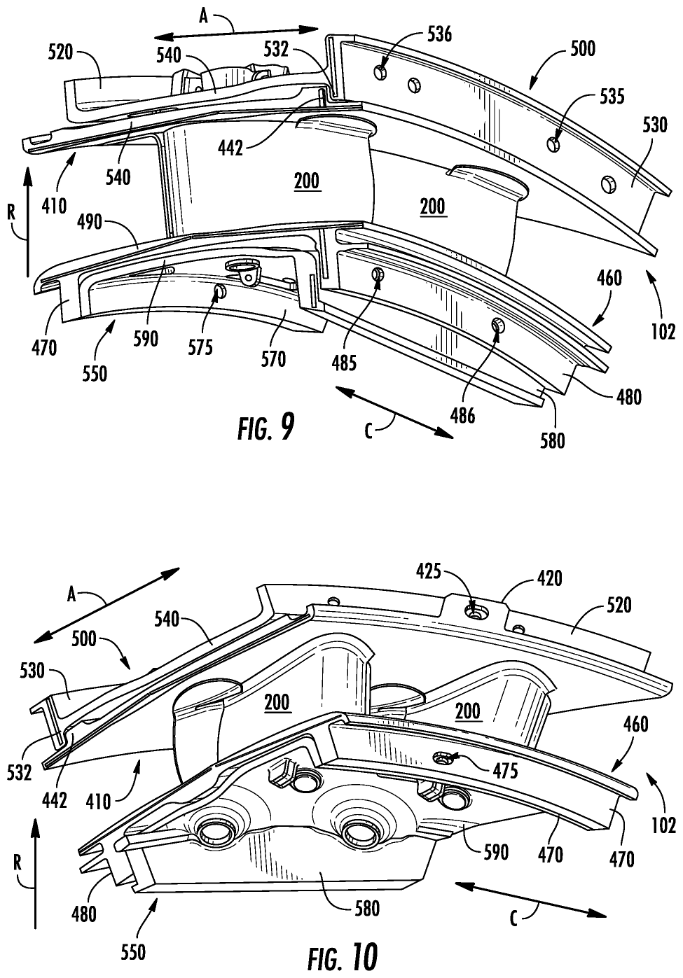

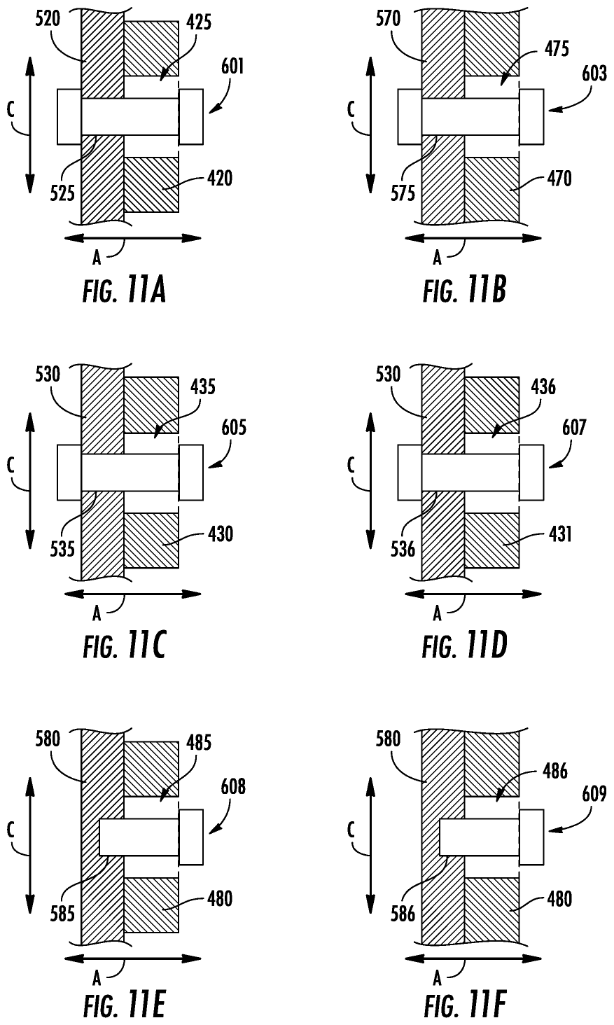

FIGS. 6-10 show an airfoil assembly 102 having attachment structures for outer and inner bands 410, 460 according to one or more embodiments, viewed, respectively, from a forward direction, a forward and radial outer direction, an aft and radial outer direction, an aft and radial inner direction, and a forward and radial inner direction. FIGS. 6-10 also include an outer hanger 500 and an inner hanger 550 to which the outer and inner bands 410, 460 are attached via the attachment structures according to one or more embodiments. According to one or more embodiments, the outer hanger 500 and the inner hanger 550 are respective examples of outer and inner support structures. While pins 601, 603, 605, 607 (see FIGS. 11A-11D) may engage with the attachment structures and corresponding attachment structures of the outer and inner hangers 500, 550 for proper attachment, the pins 601, 603, 605, 607 are not shown in FIGS. 6-10 so that the attachment structures can be clearly seen. Exemplary embodiments of the pins 601, 603, 605, 607 are depicted in FIGS. 11A through 11F and described below.

Referring to FIGS. 6-10 generally, the airfoil assembly 102 includes airfoils 200 extending between an outer band 410 and an inner band 460. More specifically, the airfoils 200 extend between a main body 440 of the outer band 410 and a main body 490 of the inner band 460. According to one or more embodiments, the airfoils 200 are formed separately from the outer band 410 and the inner band 460, and consequently assembled together as shown, for example, in FIGS. 3-5. Alternatively, the airfoils 200 may be formed integrally with the outer band 410 and the inner band 460. According to one or more embodiments, the airfoils 200, outer band 410, and/or the inner band 460 may be formed of, or may comprise, a CMC material.

Referring particularly to FIGS. 6 and 7, the outer band 410 is disposed on an outer end of the airfoils 200 in the radial direction R. According to one or more embodiments, a first attachment tab 420 extends outwards in the radial direction R from a forward end portion of the main body 440 of the outer band 410. The forward end portion of the main body 440 may be located at the upstream end of the main body 440 in the axial direction A. The first attachment tab 420 may extend from a forward edge of the main body 440 or may extend from a position slightly downstream of the forward edge of the main body 440. A base portion of the first attachment tab 420 may be tapered from the forward end portion of the main body 440. Furthermore, the corners of the first attachment tab 420 on the outer end in the radial direction R may be tapered as well. The first attachment tab 420 is tab-shaped and is an example of an outer flange.

According to one or more embodiments, the first attachment tab 420 includes an axial opening 425 formed therethrough. That is, the axial opening 425 is formed as a through-hole extending in the axial direction A through the first attachment tab 420. As shown in FIGS. 6-7, the axial opening 425 may be slot-shaped, elongated in the circumferential direction C in an ovular shape. As will be explained below, such a configuration may allow for certain benefits related to relative thermal expansion between components.

It will be appreciated, however, that while the axial opening 425 in FIGS. 6-7 is shown as a slot-shaped oval, the axial opening 425 may take other shapes. For example, the axial opening 425 may alternatively be circular or rectangularly-shaped.

According to one or more embodiments, a second attachment tab 430 and a third attachment tab 431 extend outwards in the radial direction R from an aft end portion of the main body 440 of the outer band 410. The second attachment tab 430 and the third attachment tab 431 may be spaced apart in the circumferential direction C. The aft end portion of the main body 440 may be located at the downstream end of the main body 440 in the axial direction A. The second and third attachment tabs 430, 431 may extend from an aft edge of the main body 440 or may extend from a position slightly upstream of the aft edge of the main body 440. Base portions of the second attachment tab 430 and the third attachment tab 431 may be tapered from the aft end portion of the main body 440. Furthermore, the corners of the second attachment tab 430 and the third attachment tab 431 on the outer end in the radial direction R may be tapered as well. The second and third attachment tabs 430, 431 are tab-shaped and are examples of outer flanges.

According to one or more embodiments, the second attachment tab 430 includes an axial opening 435 formed therethrough, and the third attachment tab 431 includes an axial opening 436 formed therethrough (see, particularly, FIG. 7). That is, the axial opening 435 is formed as a through-hole extending in the axial direction A through the second attachment tab 430 and the axial opening 436 is formed as a through-hole extending in the axial direction A through the third attachment tab 431. As shown in FIGS. 6-7, the axial openings 435, 436 may be elongated, e.g., in an ovular shape as shown.

It will be appreciated, however, that while the axial openings 435, 436 in FIGS. 6-7 are shown as slot-shaped ovals elongated in the circumferential direction C, the axial openings 435, 436 may take other shapes. For example, the axial openings 435, 436 may alternatively be shaped as circular or rectangularly-shaped and elongated in the circumferential direction C. Alternatively, the axial opening 436 may be circular while the axial opening 435 is elongated, or the axial opening 435 may be circular while the axial opening 436 is elongated.

According to one or more embodiments, a radial abutment surface 442 is disposed on the aft end portion of the main body 440. The radial abutment surface 442 is formed as a surface that faces aftwards in the axial direction A, and may extend continuously from one circumferential end of the main body 440 to the other circumferential end of the main body 440. According to one or more embodiments, the second and third attachment tabs 430, 431 may be positioned at or upstream of the radial abutment surface 442. According to one or more embodiments, the main body 440 may extend farther downstream in the axial direction A from the radial abutment surface 442.

The outer band 410 is disposed on an inner side of an outer hanger 500. According to one or more embodiments, the outer hanger 500 may be formed of metal. The outer hanger 500 includes a main body 540, a first radial wall 520, and a second radial wall 530. The first and second radial walls 520, 530 are examples of flanges of the outer hanger 500.

The first radial wall 520 may extend outwards in the radial direction R from a forward end portion of the main body 540 of the outer hanger 500. The forward end portion of the main body 540 may be located at the upstream end of the main body 540 in the axial direction A. The first radial wall 520 may extend from a forward edge of the main body 540 or may extend from a position slightly downstream of the forward edge of the main body 540.

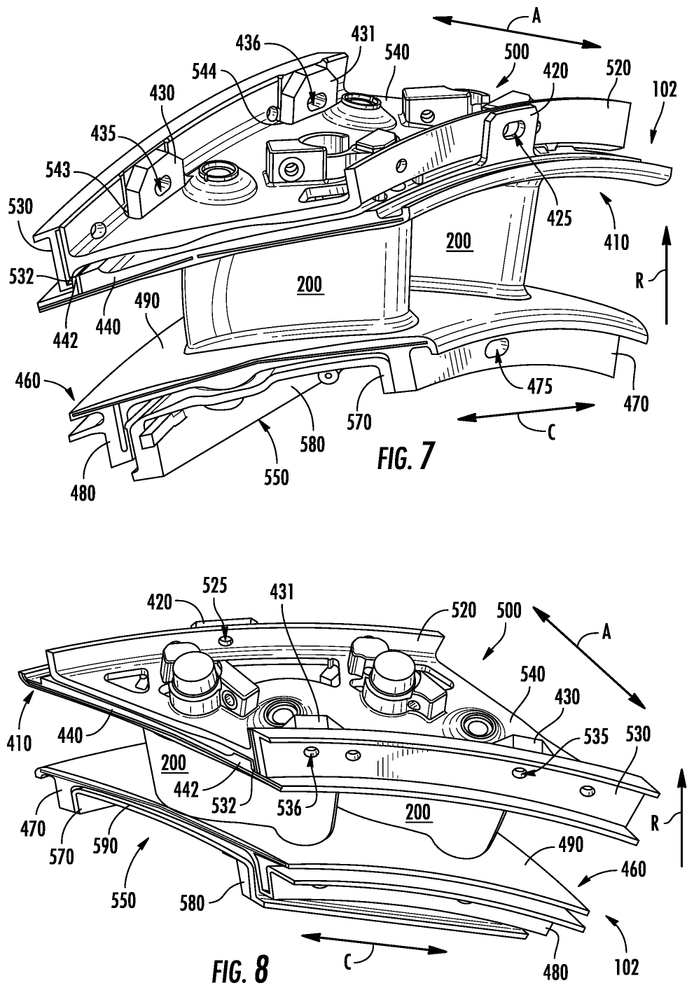

Referring now particularly to FIG. 8, according to one or more embodiments, the first radial wall 520 includes an axial opening 525 formed therethrough. That is, the axial opening 525 is formed as a through-hole extending in the axial direction A through the first radial wall 520. As shown in FIG. 8, the axial opening 525 may be circular.

It will be appreciated, however, that while the axial opening 525 in FIG. 8 is shown as circular, the axial opening 525 may take other shapes. For example, the axial opening 525 may alternatively be shaped as slot-shaped ovals or rectangularly-shaped, elongated in the circumferential direction C. According to one or more embodiments, the first radial wall 520 includes additional axial openings circumferentially spaced from the axial opening 525 that may function as alternative attachment locations for the first attachment tab 420 or may be used to attach to other elements. For example, the further attachment tab (not shown) may be attached to the additional axial openings of the first radial wall 520.

According to one or more embodiments, the main body 540 terminates in the forward axial direction A at the first radial wall 520. Alternatively, the main body 540 may extend farther upstream in the axial direction A from the first radial wall 520.

The second radial wall 530 may extend outwards in the radial direction R from an aft end portion of the main body 540 of the outer hanger 500. The aft end portion of the main body 540 may be located at the downstream end of the main body 540 in the axial direction A. The second radial wall 530 may extend from an aft edge of the main body 540 or may extend from a position slightly upstream of the aft edge of the main body 540.

According to one or more embodiments, the second radial wall 530 includes axial openings 535, 536 formed therethrough. That is, the axial openings 535, 536 are formed as through-holes extending in the axial direction through the second radial wall 530. As shown in FIG. 8, the axial openings 535, 536 may be circular.

It will be appreciated, however, that while the axial openings 535, 536 in FIG. 8 are shown as circular, the axial openings 535, 536 may take other shapes. For example, the axial openings 535, 536 may alternatively be shaped as slot-shaped ovals or rectangularly-shaped, elongated in the circumferential direction C. According to one or more embodiments, the second radial wall 530 includes additional axial openings circumferentially spaced from the axial openings 535, 536 that may be used to attach to other elements.

According to one or more embodiments, a radial abutment surface 532 is disposed on the aft end portion of the main body 540 of the outer hanger 500. The radial abutment surface 532 is formed as a surface that faces forward in the axial direction A, and may extend from one circumferential end of the outer hanger 500 to the other circumferential end of the outer hanger 500. According to one or more embodiments, the radial abutment surface 532 may be a forward-facing surface of the second radial wall 530. According to one or more embodiments, the main body 540 terminates at the second radial wall 530. Alternatively, the main body 540 may extend farther downstream in the axial direction A from the second radial wall 530.

Referring back briefly to FIGS. 6 and 7, the main body 540 may further include radial openings 543, 544 extending therethrough. The radial openings 543, 544 are formed as through-holes extending in the radial direction R through the second radial wall 530. The radial openings 543, 544 are shaped and spaced such the second and third attachment tabs 430, 431 may pass therethrough in the radial direction R. According to one or more embodiments, the radial openings 543, 544 are located immediately forward of the second radial wall 530. According to one or more embodiments, the radial openings 543, 544 are rectangularly-shaped. The radial openings 543, 544 are examples of apertures of the outer hanger 500.

As shown in FIGS. 6-10, generally, when assembled, the outer band 410 is disposed on an inner side of the outer hanger 500 in the radial direction R. According to one or more embodiments, the outer band 410 and the outer hanger 500 are spaced apart in the radial direction R such that the first, second, and third attachment tabs 420, 430, 431 support the radial load between the outer band 410 and the outer hanger 500. Alternatively, the inner radial surface of the main body 540 of the outer hanger 500 may at least partially abut the outer radial surface of the main body 440 of the outer band 410.

According to one or more embodiments, the radial abutment surface 442 of the outer band 410 abuts the radial abutment surface 532 of the outer hanger 500. According to one or more embodiments, the axial contact between the radial abutment surface 442 and the radial abutment surface 532 may be the only axial contact between the outer band 410 and the outer hanger 500.

According to one or more embodiments, a seal may be disposed between the radial abutment surface 442 and the outer band 410 abuts the radial abutment surface 532 of the outer hanger 500 so as to prevent airflow leakage. For example, the seal may be a wire seal extending in the redial direction.

According to one or more embodiments, in addition to the axial contact between the radial abutment surface 442 and the radial abutment surface 532, the first attachment tab 420 may be disposed on a forward side of the first radial wall 520 in the axial direction A such that an axially aft surface of the first attachment tab 420 abuts an axially forward surface of the first radial wall 520.

According to one or more embodiments, the axial opening 425 of the first attachment tab 420 aligns with the axial opening 525 of the first radial wall 520.

According to one or more embodiments, the second attachment tab 430 is passed radially through the radial opening 543 such that the second attachment tab 430 is disposed on a forward side of the second radial wall 530 in the axial direction A.

According to one or more embodiments, in addition to the axial contact between the radial abutment surface 442 and the radial abutment surface 532 and/or axial contact between the first attachment tab 420 and the first radial wall 520, the axially aft surface of the second attachment tab 430 may abut an axially forward surface of the second radial wall 530. According to one or more embodiments, the axial opening 435 of the second attachment tab 430 aligns with the axial opening 535 of the second radial wall 530.

According to one or more embodiments, the third attachment tab 431 is passed radially through the radial opening 544 such that the third attachment tab 431 is disposed on a forward side of the second radial wall 530 in the axial direction A.

According to one or more embodiments, in addition to the axial contact between the radial abutment surface 442 and the radial abutment surface 532, the axial contact between the first attachment tab 420 and the first radial wall 520, and/or axial contact between the second attachment tab 430 and the second radial wall 530, an axially aft surface of the third attachment tab 431 may abut an axially forward surface of the second radial wall 530, with the axial opening 436 of the third attachment tab 431 aligning with the axial opening 536 of the second radial wall 530.

The inner band 460 is disposed on an inner end of the airfoils 200 in the radial direction R. According to one or more embodiments, a first radial wall 470 extends inwards in the radial direction R from a forward end portion of the main body 490 of the inner band 460. The forward end portion of the main body 490 may be located at the upstream end of the main body 490 in the axial direction A. The first radial wall 470 may extend from a forward edge of the main body 490 or may extend from a position slightly downstream of the forward edge of the main body 490. The first radial wall 470 is an example of an inner flange.

According to one or more embodiments, the first radial wall 470 includes an axial opening 475 formed therethrough. That is, the axial opening 475 is formed as a through-hole extending in the axial direction A through the first radial wall 470. As shown in FIGS. 6-7 and 10, the axial opening 475 may be slot-shaped, elongated in the circumferential direction C. While the axial opening 475 in FIGS. 6-7 and 10 are shown as slot-shaped ovals, the axial opening 475 may take other shapes. For example, the axial opening 475 may alternatively be circular or rectangularly-shaped.

According to one or more embodiments, a second radial wall 480 extends inwards in the radial direction R from an aft end portion of the main body 490 of the inner band 460. The aft end portion of the main body 490 may be located at the downstream end of the main body 490 in the axial direction A. The second radial wall 480 may extend from an aft edge of the main body 490 or may extend from a position slightly upstream of the aft edge of the main body 490. According to one or more embodiments, the second radial wall 480 may include axial openings 485, 486 formed therethrough. The second radial wall 480 is an example of an inner flange.

The inner band 460 is disposed on an outer side of an inner hanger 550. According to one or more embodiments, the inner hanger 550 may be formed of metal. The inner hanger 550 includes a main body 590, a first radial wall 570, and a second radial wall 580. The first and second radial walls 570, 580 are examples of flanges of the inner hanger 550.

The first radial wall 570 may extend inwards in the radial direction R from a forward end portion of the main body 590 of the inner hanger 550. The forward end portion of the main body 590 may be located at the upstream end of the main body 590 in the axial direction A. The first radial wall 570 may extend from a forward edge of the main body 590 or may extend from a position slightly downstream of the forward edge of the main body 590.

According to one or more embodiments, the first radial wall 570 includes an axial opening 575 formed therethrough. That is, the axial opening 575 is formed as a through-hole extending in the axial direction A through the first radial wall 570. As shown in FIG. 9, the axial opening 575 may be circular. While the axial opening 575 in FIG. 9 is shown as circular, the axial opening 575 may take other shapes. For example, the axial opening 575 may alternatively be shaped as slot-shaped ovals or rectangularly-shaped, elongated in the circumferential direction C. Although not shown, according to one or more embodiments, the first radial wall 570 may include additional axial openings circumferentially spaced from the axial opening 575 that may function as alternative attachment locations for the first radial wall 470 or may be used to attach to other elements.

According to one or more embodiments, the main body 590 terminates in the forward axial direction A at the first radial wall 570. Alternatively, the main body 590 may extend farther upstream in the axial direction A from the first radial wall 570.

The second radial wall 580 may extend inwards in the radial direction R from an aft end portion of the main body 590 of the inner hanger 550. The aft end portion of the main body 590 may be located at the downstream end of the main body 590 in the axial direction A. The second radial wall 580 may extend from an aft edge of the main body 590 or may extend from a position slightly upstream of the aft edge of the main body 590.

According to one or more embodiments, the second radial wall 580 may include axial openings for attaching the second radial wall 480 of the inner band 460 and may further include additional axial openings circumferentially spaced from the axial opening that may be used to attach to other elements. For example, the second radial wall 580 may include axial openings 585, 586 formed as blind holes on the forward surface thereof. That is, as shown in FIGS. 11E-11F, the axial openings 585, 586 may not extend all the way through the radial wall 580 to the aft surface thereof. Alternatively, the axial openings 585, 586 may be formed as through-holes.

According to one or more embodiments, the main body 590 terminates at the second radial wall 580. Alternatively, the main body 590 may extend farther downstream in the axial direction A from the second radial wall 580.

As shown in FIGS. 6-10, when assembled, the inner band 460 is disposed on an outer side of the inner hanger 500 in the radial direction R. According to one or more embodiments, the inner band 460 and the inner hanger 550 are spaced apart in the radial direction R such that the first radial wall 470 supports the radial load between the inner band 460 and the inner hanger 550. Alternatively, the outer radial surface of the main body 590 of the inner hanger 550 may at least partially abut the inner radial surface of the main body 490 of the inner band 460.

According to one or more embodiments, the first radial wall 470 is disposed on a forward side of the first radial wall 570 in the axial direction A, such that an axially aft surface of the first radial wall 470 abuts an axially forward surface of the first radial wall 570, with the axial opening 475 of the first radial wall 470 aligning with the axial opening 575 of the first radial wall 570.

According to one or more embodiments, the second radial wall 480 is disposed on an aft side of the second radial wall 580 in the axial direction A, and an axially forward surface of the second radial wall 480 abuts an axially aft surface of the second radial wall 580. Although not shown, the second radial wall 480 of the inner band and the second radial wall 580 of the inner hanger may include axial openings and, in such a case, the axial opening of the second radial wall 480 may align with the axial opening of the second radial wall 580.

FIG. 11A is a cross-sectional view from a radial direction of an attachment structure for attaching the first attachment tab 420 of the outer band 410 to the first radial wall 520 of the outer hanger 500 according to one or more embodiments. When assembled, the axial opening 425 of the first attachment tab 420 of the outer band 410 is axially aligned with the axial opening 525 of the first radial wall 520 of the outer hanger 500. The alignment of the axial openings 425, 525 allows a pin 601 to pass therethrough. For example, FIG. 11A shows the pin 601 being a nut-and-bolt structure.

However, in other exemplary embodiments, any other suitable structures that pass through the axial openings 425, 525 to allow for attachment of the first attachment tab 420 to the first radial wall 520 may be employed. For example, the pin 601 may be any elongated member, such as an elongated fastener, such as an elongated rotatable fastener, or an elongated permanent fixture (e.g., welded together, to one of the components, etc.). The diameter of the pin 601 may correspond to the inner diameter of the axial opening 525 of the first radial wall 520 and a height of the axial opening 425 of the first attachment tab 420.

As noted above, the outer band 410 and the outer hanger 500 may be formed of different materials. For example, the outer band 410 may be formed of or comprise CMC material, and the outer hanger 500 may be formed of metal. This may result in different rates of thermal expansion between the outer band 410 and the outer hanger 500. For example, the outer hanger 500 may expand more quickly than the outer band 410 when they are exposed to heat during operation of the engine.

However, the axial opening 425 of the first attachment tab 420 may be elongated in the circumferential direction C as shown in FIG. 11A and, as such, the circumferential dimension of the axial opening 425 may be significantly greater than the diameter of the pin 601 (e.g., at least 10% greater, such as at least 20% greater, such as at least 50% greater, such as up to 500% greater). Thus, if one of the outer band 410 and the outer hanger 500 expands more quickly than the other, the pin 601 may shift inside the elongated axial opening 425, allowing the first attachment tab 420 to shift in the circumferential direction C with respect to the first radial wall 520. This shift between the first attachment tab 420 and the first radial wall 520 may prevent stresses that could occur due to the different rates of expansion.

FIG. 11B is a cross-sectional view from a radial direction of an attachment structure for attaching the first radial wall 470 of the inner band 460 to the first radial wall 570 of the inner hanger 550 according to one or more embodiments. When assembled, the axial opening 475 of the first radial wall 470 of the inner band 460 is axially aligned with the axial opening 575 of the first radial wall 570 of the inner hanger 550. The alignment of the axial openings 475, 575 allows a pin 603 to pass therethrough. For example, FIG. 11B shows the pin 603 being a nut-and-bolt structure. However, other suitable structures that pass through the axial openings 475, 575 to allow for attachment of the first radial wall 470 to the first radial wall 570 may be employed. For example, the pin 601 may be any elongated member, such as an elongated fastener, such as an elongated rotatable fastener, or an elongated permanent fixture (e.g., welded together, to one of the components, etc.). The diameter of the pin 603 may correspond to the inner diameter of the axial opening 575 of the first radial wall 570 and a height of the axial opening 475 of the first radial wall 470.

As noted above, the inner band 460 and the inner hanger 550 may be formed of different materials. For example, the inner band 460 may be formed of or comprise CMC material, and the inner hanger 550 may be formed of metal. This may result in different rates of thermal expansion between the inner band 460 and the inner hanger 550. For example, the inner hanger 550 may expand more quickly than the inner band 460 when they are exposed to heat during operation of the engine.

However, the axial opening 475 of the first radial wall 470 may be elongated in the circumferential direction C as shown in FIG. 11B and, as such, the circumferential dimension of the axial opening 475 may be significantly greater than the diameter of the pin 603. Thus, if one of the inner band 460 and the inner hanger 550 expands more quickly than the other, the pin 603 may shift inside the elongated axial opening 475, allowing the first radial wall 470 to shift in the circumferential direction C with respect to the first radial wall 570. This shift between the first radial wall 470 and the first radial wall 570 may prevent stresses that could occur due to the different rates of expansion.

FIG. 11C is a cross-sectional view from a radial direction of an attachment structure for attaching the second attachment tab 430 of the outer band 410 to the second radial wall 530 of the outer hanger 500 according to one or more embodiments. When assembled, the axial opening 435 of the second attachment tab 430 of the outer band 410 is axially aligned with the axial opening 535 of the second radial wall 530 of the outer hanger 500. The alignment of the axial openings 435, 535 allows a pin 605 to pass therethrough. For example, FIG. 11C shows the pin 605 being a nut-and-bolt structure. However, other suitable structures that pass through the axial openings 435, 535 to allow for attachment of the second attachment tab 430 to the second radial wall 530 may be employed. For example, the pin 601 may be any elongated member, such as an elongated fastener, such as an elongated rotatable fastener, or an elongated permanent fixture (e.g., welded together, to one of the components, etc.). The diameter of the pin 605 may correspond to the inner diameter of the axial opening 535 of the second radial wall 530 and a height of the axial opening 435 of the second attachment tab 430.

FIG. 11D is a cross-sectional view from a radial direction of an attachment structure for attaching the third attachment tab 431 of the outer band 410 to the second radial wall 530 of the outer hanger 500 according to one or more embodiments. When assembled, the axial opening 436 of the third attachment tab 431 of the outer band 410 is axially aligned with the axial opening 536 of the second radial wall 530 of the outer hanger 500. The alignment of the axial openings 436, 536 allows a pin 607 to pass therethrough. For example, FIG. 11D shows the pin 607 being a nut-and-bolt structure. However, other suitable structures that pass through the axial openings 436, 536 to allow for attachment of the third attachment tab 431 to the second radial wall 530 may be employed. For example, the pin 601 may be any elongated member, such as an elongated fastener, such as an elongated rotatable fastener, or an elongated permanent fixture (e.g., welded together, to one of the components, etc.). The diameter of the pin 607 may correspond to the inner diameter of the axial opening 536 of the second radial wall 531 and a height of the axial opening 436 of the third attachment tab 431.

FIGS. 11E-11F are cross-sectional views from a radial direction of attachment structure for attaching the second radial wall 480 of the inner band 460 to the second radial wall 580 of the inner hanger 550 according to one or more embodiments. When assembled, the axial openings 485, 486 of the second radial wall 480 of the inner band 460 are axially aligned with the axial openings 585, 586 of the second radial wall 580 of the inner hanger 550. The alignment of the axial openings 485, 486, 585, 586 allows pins 608, 609 to pass therethrough. For example, FIGS. 11E and 11F shows the pins 608, 609 being nut-and-bolt structures. However, other suitable structures that pass through the axial openings 485, 486, 585, 586 to allow for attachment of the second radial wall 480 to the second radial wall 580 may be employed. For example, the pin 601 may be any elongated member, such as an elongated fastener, such as an elongated rotatable fastener, or an elongated permanent fixture (e.g., welded together, to one of the components, etc.). The diameter of the pins 608, 609 may correspond to the inner diameters of the axial openings 585, 586 of the second radial wall 580 and heights of the axial openings 485, 486 of the second radial wall 480.

During operation, the axial airflow may abut the forward surface of the airfoils 200 to create an aftward axial force on the airfoils 200 that is transferred to the outer and inner bands 410, 460. With the outer band 410, the aftward axial force may be passed from the radial abutment surface 442 of the main body 440 to the corresponding radial abutment surface 532 of the second radial wall 530. Alternatively or additionally, the aftward axial force may be passed from the aft surface of the first attachment tab 420 to the forward surface of the first radial wall 520, and from the aft surfaces of the second and third attachment tabs 430, 431 to the forward surface of the second radial wall 530. Thereby, the aftward axial forces are transferred from the outer band 410 to the outer hanger 500, while the first, second, and third attachment tabs 420, 430, 431 secure the outer band 410 to the outer hanger 500. With the inner band 460, the aftward axial force may be passed from the aft surface of the first radial wall 470 to the forward surface of the first radial wall 570. Thereby, the aftward axial forces may be transferred from the inner band 460 to the inner hanger 550, while the first radial wall 470 secures the inner band 460 to the inner hanger 550. Furthermore, although not shown, additional attachment structures may also attach the outer band 410 to the outer hanger 500 and the inner band 460 to the inner hanger 550. Alternatively, the aftward axial forces from the airfoil loads may pass directly to the outer hanger 500 and the inner hanger 550 via different attachment features (not shown) in addition to or instead of through the outer band 410 and the inner band 460.

Additionally, according to one or more embodiments, a seal may be disposed between a forward surface of the second radial wall 480 of the inner band and an aft surface of the second radial wall 580 of the inner hanger so as to prevent airflow leakage therebetween. Additionally or alternatively, a seal may be disposed between an aft surface of the first radial wall 470 and a forward surface of the first radial wall 570. For example, the seals may be wire seals extending in the circumferential direction C.

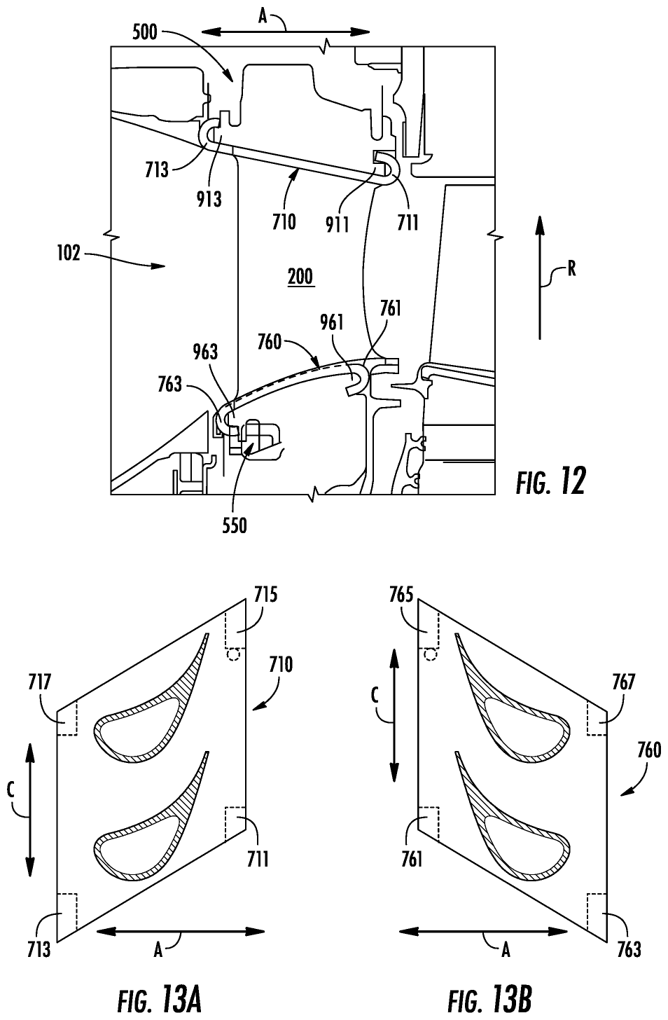

FIG. 12 is a cross-sectional view from a circumferential direction C of an airfoil assembly 102 having attachment structures for outer and inner bands 710, 760 according to one or more embodiments. FIG. 13A shows an outer band 710 having attachment structures according to one or more embodiments viewed from a radial inner direction. FIG. 13B shows an inner band having attachment structures according to one or more embodiments viewed from a radial outer direction.

The attachment structures for the outer band 710 are in the form of first, second, third, and fourth hooks 711, 713, 715, 717. According to one or more embodiments, a hook may be defined as an element that is shaped to have a curved or a bent portion that is shaped to secure a structure therein. As shown in FIGS. 12 and 13A, each of the first, second, third, and fourth hooks 711, 713, 715, 717 extend in an outer radial direction away the airfoil 200 and towards the outer hanger 500. The first hook 711 and the third hook 715 are disposed on opposite circumferential ends of the downstream axial end of the outer band 710, and the second hook 713 and the fourth hook 717 are disposed on opposite circumferential ends of the upstream axial end of the outer band 710. The first and third hooks 711, 715 slide onto an axial flange 911 on the downstream end of the outer hanger 500, and the second and fourth hooks 713, 717 slide onto an axial flange 913 on the upstream end of the outer hanger 500. The terminal ends of each of the first, second, third, and fourth hooks 711, 713, 715, 717 may abut radial walls of the outer hanger 500. The terminal ends of the first and second hooks 711, 713 may extend toward each other in the axial direction A, and the terminal ends of the third and fourth hooks 715, 717 may extend toward each other in the axial direction A.

The attachment structures for the inner band 760 are in the form of first, second, third, and fourth hooks 761, 763, 765, 767. As shown in FIGS. 12 and 13B, each of the first, second, third, and fourth hooks 761, 763, 765, 767 extend in an inner radial direction away the airfoil 200 and towards the inner hanger 500. The first hook 761 and the third hook 765 are disposed on opposite circumferential ends of the downstream axial end of the inner band 760, and the second hook 763 and the fourth hook 767 are disposed on opposite circumferential ends of the upstream axial end of the inner band 760. The first and third hooks 761, 765 slide onto an axial flange 961 on the downstream end of the inner hanger 550, and the second and fourth hooks 763, 767 slide onto an axial flange 963 on the upstream end of the inner hanger 550. The terminal ends of each of the first, second, third, and fourth hooks 761, 763, 765, 767 may abut radial walls of the inner hanger 550. The terminal ends of the first and second hooks 761, 763 may extend toward each other in the axial direction A, and the terminal ends of the third and fourth hooks 765, 767 may extend toward each other in the axial direction A.

Once the first, second, third, and fourth hooks 711, 713, 715, 717 are secured on the axial flanges 911, 913 of the outer hanger 500 and the first, second, third, and fourth hooks 761, 763, 765, 767 are secured on the axial flanges 961, 963 of the inner hanger 550, the outer and inner bands 710, 760, as well as the airfoil 200 extending therebetween, are removably attached to the outer and inner hangers 500, 550.

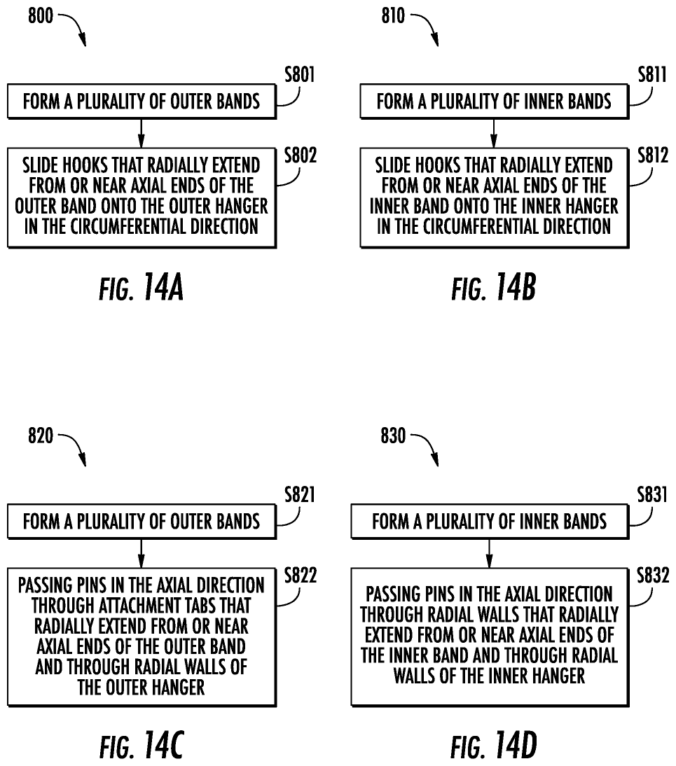

FIG. 14A shows a method 800 of assembling an airfoil assembly 102 onto an outer hanger 500 according to one or more embodiments. The method 800 removably attaches outer bands 710 onto an outer hanger 500 via first, second, third, and fourth hooks 711, 713, 715, 717. The method 800 includes forming S801 a plurality of outer bands 710. According to one or more embodiments, the outer bands 710 may be formed of or comprise CMC material. The method 800 further includes sliding S802 the first, second, third, and fourth hooks 711, 713, 715, 717 that radially extend from or near axial ends of each of the outer bands 710 onto the outer hanger 500 in the circumferential direction C.

FIG. 14B shows a method 810 of assembling an airfoil assembly 102 onto an inner hanger 550 according to one or more embodiments. The method 810 removably attaches inner bands 760 onto an inner hanger 550 via first, second, third, and fourth hooks 761, 763, 765, 767. The method 810 includes forming S811 a plurality of inner bands 760. According to one or more embodiments, the inner bands 760 may be formed of or comprise CMC material. The method 810 further includes sliding S812 the first, second, third, and fourth hooks 761, 763, 765, 767 that radially extend from or near axial ends of each of the inner bands 760 onto the inner hanger 550 in the circumferential direction C.

FIG. 14C shows a method 820 of assembling an airfoil assembly 102 onto an outer hanger 500 according to one or more embodiments. The method 820 removably attaches outer bands 410 onto an outer hanger 500 via first, second, and third attachment tabs 420, 430, 431. The method 820 includes forming S821 a plurality of outer bands 410. According to one or more embodiments, the outer bands 410 may be formed of or comprise CMC material. The method 820 further includes passing pins 601, 605, 607 in the axial direction A through first, second, and third attachment tabs 420, 430, 431 that radially extend from or near axial ends of the outer band 410 and through first and second radial walls 520, 530 of the outer hanger 500.

FIG. 14D shows a method 830 of assembling an airfoil assembly 102 onto an inner hanger 550 according to one or more embodiments. The method 830 removably attaches inner bands 460 onto an inner hanger 500 via first and second radial walls. The method 830 includes forming 5831 a plurality of inner bands 460. According to one or more embodiments, the inner bands 460 may be formed of or comprise CMC material. The method 830 further includes passing a pin 603 in the axial direction A through a first radial wall 470 that radially extends from or near an axial end of the inner band 460 and through a first radial wall 570 of the inner hanger 550. The method 830 may further include passing a pin (not shown) in the axial direction A through a second radial wall 480 that radially extends from or near an axial end of the inner band 460 and through a second radial wall 580 of the inner hanger 550.

One or more embodiments described above may simplify manufacturing for cost-out and yield. Additionally, one or more embodiments described above may decrease and/or eliminate stresses at the airfoil to band interfaces. One or more embodiments may effectively locate and attach outer and inner bands to outer and inner hangers.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

An airfoil assembly defining an axial direction, a radial direction, and a circumferential direction, comprising: an airfoil; and an outer band disposed on an outer end of the airfoil in the radial direction, wherein the outer band comprises an outer attachment structure configured to secure the outer band to an outer support structure on an outer side of the outer band.

The airfoil assembly according to one or more of these clauses, wherein the airfoil and the outer band are formed of or includes ceramic matrix composite (CMC).

The airfoil assembly according to one or more of these clauses, wherein the outer attachment structure comprises: a first outer hook that radially extends from or near a first axial end of the outer band, and a second outer hook that radially extends from or near a second axial end of the outer band, and wherein the first and second outer hooks are configured to slide onto the outer support structure in the circumferential direction to removably secure the airfoil assembly on the outer support structure.

The airfoil assembly according to one or more of these clauses, wherein terminal ends of the first and second outer hooks extend towards each other in the axial direction.

The airfoil assembly according to one or more of these clauses, wherein the outer attachment structure comprises: a first outer flange that radially extends from or near a first axial end of the outer band, and a second outer flange that radially extends from or near a second axial end of the outer band, wherein the first outer flange defines a first opening extending in the axial direction, wherein the second outer flange defines a second opening extending in the axial direction, and wherein the first and second openings are configured to have pins pass therethrough to corresponding openings on the outer support structure to removably secure the airfoil assembly on the outer support structure.

The airfoil assembly according to one or more of these clauses, wherein the first outer flange is on an upstream side of the outer attachment structure relative to the second outer flange in the axial direction.

The airfoil assembly according to one or more of these clauses, wherein the first opening is elongate and is larger in the circumferential direction than the radial direction.

The airfoil assembly according to one or more of these clauses, further comprising: a radial abutment surface that extends from an upper surface of the outer band, wherein the radial abutment surface faces an upstream side in the axial direction, wherein the radial abutment surface is separate from the first outer flange and the second outer flange, and wherein the radial abutment surface is configured to abut a corresponding abutment surface of the outer support structure.

The airfoil assembly according to one or more of these clauses, wherein the second outer flange is tab-shaped and is configured to extend radially through an aperture in the outer support structure.

The airfoil assembly according to one or more of these clauses, further comprising: a third outer flange that is tab-shaped, wherein the third outer flange is configured to extend radially through another aperture in the outer support structure, wherein the third outer flange is disposed adjacent to the second outer flange in the circumferential direction and wherein the third outer flange has a third opening configured to have a pin pass therethrough to a corresponding opening on the outer support structure.

The airfoil assembly according to one or more of these clauses, wherein upstream surfaces of the first and second outer flanges in the axial direction are configured to abut radial surfaces of the outer support structure.

The airfoil assembly according to one or more of these clauses, wherein the airfoil and outer band are formed as separate pieces.

The airfoil assembly according to one or more of these clauses, further comprising: an inner band disposed on an inner end of the airfoil in the radial direction, wherein the inner band comprises an inner attachment structure configured to removably secure the inner band to an inner support structure on an inner side of the inner band.

The airfoil assembly according to one or more of these clauses, wherein the inner attachment structure comprises: a first inner hook that radially extends from or near a first axial end of the inner band, and a second inner hook that radially extends from or near a second axial end of the inner band, and wherein the first and second inner hooks are configured to slide onto the inner support structure in the circumferential direction to removably secure the airfoil assembly on the inner support structure.

The airfoil assembly according to one or more of these clauses, wherein the inner attachment structure comprises: a first inner flange that radially extends from or near a first axial end of the inner band, and a second inner flange that radially extends from or near a second axial end of the inner band, wherein the first inner flange comprises a first opening in the axial direction, wherein the second inner flange comprises a second opening in the axial direction, and wherein the first and second openings are configured to have pins pass therethrough to corresponding openings on the inner support structure to removably secure the airfoil assembly on the inner support structure.

The airfoil assembly according to one or more of these clauses, wherein the first inner flange is on an upstream side of the second inner flange in the axial direction.

The airfoil assembly according to one or more of these clauses, wherein the first opening is elongate and is larger in the circumferential direction than the radial direction.

The airfoil assembly according to one or more of these clauses, wherein a downstream surface of the first inner flange and an upstream surface of the second inner flange are configured to abut the inner support structure.

A gas turbine engine comprising: an outer support structure; and an airfoil assembly defining an axial direction, a radial direction, and a circumferential direction, and comprising: an airfoil; an outer band disposed on an outer end of the airfoil in the radial direction; and an inner band disposed on an inner end of the airfoil in the radial direction, wherein the outer band comprises an outer attachment structure configured to secure the outer band to an outer support structure on an outer side of the outer band, wherein the outer band comprises an attachment structure, and wherein the attachment structure attaches the outer band to the outer support structure.

A method of assembling an airfoil assembly onto an outer support structure, the airfoil assembly defining an axial direction, a radial direction, and a circumferential direction, and comprising an airfoil, an outer band disposed on an outer end of the airfoil in the radial direction, and an inner band disposed on an inner end of the airfoil in the radial direction, the method comprising: attaching the outer band to the outer support structure via an attachment structure of the outer band, wherein attaching the outer band to the outer support structure comprises one of: sliding first and second outer hooks that radially extend from or near axial ends of the outer band onto the outer support structure in the circumferential direction, and passing securing pins in the axial direction through first and second outer flanges that radially extend from or near axial ends of the outer band and through flanges of the outer support structure.

1. An airfoil assembly defining an axial direction, a radial direction, and a circumferential direction, comprising:
an airfoil; and
an outer band disposed on an outer end of the airfoil in the radial direction,
wherein the outer band comprises an outer attachment structure configured to secure the outer band to an outer support structure on an outer side of the outer band.

2. The airfoil assembly according to claim 1, wherein the airfoil and the outer band are formed of or includes ceramic matrix composite (CMC).

3. The airfoil assembly according to claim 1,
wherein the outer attachment structure comprises:
a first outer hook that radially extends from or near a first axial end of the outer band, and
a second outer hook that radially extends from or near a second axial end of the outer band, and
wherein the first and second outer hooks are configured to slide onto the outer support structure in the circumferential direction to removably secure the airfoil assembly on the outer support structure.

4. The airfoil assembly according to claim 3, wherein terminal ends of the first and second outer hooks extend towards each other in the axial direction.

5. The airfoil assembly according to claim 1,
wherein the outer attachment structure comprises:
a first outer flange that radially extends from or near a first axial end of the outer band, and
a second outer flange that radially extends from or near a second axial end of the outer band,
wherein the first outer flange defines a first opening extending in the axial direction,
wherein the second outer flange defines a second opening extending in the axial direction, and
wherein the first opening is configured to have a first pin pass therethrough to a first corresponding opening on the outer support structure and the second opening is configured to have a second pin pass therethrough to a second corresponding opening on the outer support structure, wherein the outer support structure is removably secured to the airfoil assembly on the outer support structure by the first pin and the second pin.

6. The airfoil assembly according to claim 5, wherein the first outer flange is on an upstream side of the outer attachment structure relative to the second outer flange in the axial direction.

7. The airfoil assembly according to claim 6, wherein the first opening is elongate and is larger in the circumferential direction than the radial direction.

8. The airfoil assembly according to claim 5, further comprising:
a radial abutment surface that extends from an upper surface of the outer band,
wherein the radial abutment surface faces an upstream side in the axial direction,
wherein the radial abutment surface is separate from the first outer flange and the second outer flange, and
wherein the radial abutment surface is configured to abut a corresponding abutment surface of the outer support structure.

9. The airfoil assembly according to claim 5, wherein the second outer flange is tab-shaped and is configured to extend radially through a first aperture in the outer support structure.

10. The airfoil assembly according to claim 9, further comprising:
a third outer flange that is tab-shaped,
wherein the third outer flange is configured to extend radially through a second aperture in the outer support structure,
wherein the third outer flange is disposed adjacent to the second outer flange in the circumferential direction and
wherein the third outer flange has a third opening configured to have a third pin pass therethrough to a corresponding opening on the outer support structure.

11. The airfoil assembly according to claim 5, wherein upstream surfaces of the first and second outer flanges in the axial direction are configured to abut radial surfaces of the outer support structure.

12. The airfoil assembly according to claim 1, wherein the airfoil and the outer band are formed as separate pieces.

13. The airfoil assembly according to claim 1, further comprising:
an inner band disposed on an inner end of the airfoil in the radial direction, wherein the inner band comprises an inner attachment structure configured to removably secure the inner band to an inner support structure on an inner side of the inner band.

14. The airfoil assembly according to claim 13, wherein the inner attachment structure comprises:
a first inner hook that radially extends from or near a first axial end of the inner band, and
a second inner hook that radially extends from or near a second axial end of the inner band, and
wherein the first and second inner hooks are configured to slide onto the inner support structure in the circumferential direction to removably secure the airfoil assembly on the inner support structure.

15. The airfoil assembly according to claim 13, wherein the inner attachment structure comprises:
a first inner flange that radially extends from or near a first axial end of the inner band, and
a second inner flange that radially extends from or near a second axial end of the inner band,
wherein the first inner flange comprises a first opening in the axial direction,
wherein the second inner flange comprises a second opening in the axial direction, and
wherein the first and second openings are configured to have pins pass therethrough to corresponding openings on the inner support structure to removably secure the airfoil assembly on the inner support structure.

16. The airfoil assembly according to claim 15, wherein the first inner flange is on an upstream side of the second inner flange in the axial direction.

17. The airfoil assembly according to claim 15, wherein the first opening is elongate and is larger in the circumferential direction than the radial direction.

18. The airfoil assembly according to claim 15 wherein a downstream surface of the first inner flange and an upstream surface of the second inner flange are configured to abut the inner support structure.

19. A gas turbine engine comprising:
an outer support structure; and
an airfoil assembly defining an axial direction, a radial direction, and a circumferential direction, and comprising:
an airfoil; and
an outer band disposed on an outer end of the airfoil in the radial direction and defining an outer side, wherein the outer band comprises an attachment structure, the attachment structure securing the outer band to the outer support structure on the outer side of the outer band.

20. A method of assembling an airfoil assembly onto an outer support structure, the airfoil assembly defining an axial direction, a radial direction, and a circumferential direction, wherein the airfoil assembly comprises an airfoil and an outer band disposed on an outer end of the airfoil in the radial direction, the method comprising:
attaching the outer band to the outer support structure via an attachment structure of the outer band by
passing securing pins in the axial direction through first and second outer flanges that radially extend from or near axial ends of the outer band and through flanges of the outer support structure.
